(19) United States
(12) Patent Application Publication
(10) Pub. No.: US 2016/0086190 A1
(43) Pub. Date: Mar. 24, 2016

(54) SYSTEMS AND METHODS FOR COMPREHENSIVE CONSUMER RELATIONSHIP MANAGEMENT

(71) Applicant: III Holdings 1, LLC, Wilmington, DE (US)

(72) Inventors: Zane Bohrer, Frisco, TX (US); Jane Cook, Mountain Lakes, NJ (US); Richard Anthony Delgado, Dallas, TX (US); Jennifer S. Ingram, Larchmont, NY (US); Kevin Lawrence, Philadelphia, PA (US); Randi Schochet, Tarrytown, NY (US); Tom Verutes, Rockville Centre, NY (US); Michael Cohen, New York, NY (US); Mark Kiernan, New York, NY (US); Pedro Perez, New York, NY (US)

(21) Appl. No.: 14/862,994

(22) Filed: Sep. 23, 2015

Related U.S. Application Data
(63) Continuation of application No. 14/467,798, filed on Aug. 25, 2014, now abandoned.
Application No. 14/467,798 is a continuation of application No. 12/243,660, filed on Oct. 1, 2008, now abandoned.

(51) Int. Cl. G06Q 30/00; G06Q 30/02

(52) U.S. Cl. CPC G06Q 30/01; G06Q 30/0202

(57) ABSTRACT

A comprehensive consumer relationship management system is disclosed. The comprehensive consumer relationship management system includes dispute resolution, customized data modeling, advertising assistance, and secure communications. By providing value added features, the comprehensive consumer relationship management system may strengthen consumer relationships by, for example, creating detailed data analysis to aid in making business decisions and facilitating secure communications among diverse consumers.

### FIELD OF INVENTION

The present invention generally relates to comprehensive consumer relationship management. More specifically, the present invention relates to systems and methods for providing consumers with electronic relationship management tools and customized data models.

### BACKGROUND OF THE INVENTION

Consumer relationship management is crucial to the sustainability of a business. Many businesses must effectively acquire, maintain, and end consumer relationships in order to survive. Many businesses usually choose to provide these services with consumer service managers who manage the needs of a given set of consumers using traditional methods. Some businesses automate pieces of the consumer relationship management lifecycle. For example, disputes and account changes are handled via consumer service managers, but account inquiries and payment operations may be handled through a web site. However, these systems tend to over-utilize people resources and may lead to consumer confusion as to the appropriate forum to present their issue. In addition, consumer relationship management systems tend to be structured using a top-down model. In this model, the business deals with one consumer at a time and consumers typically do not interact.

Businesses often provide little added value to the consumers via their consumer relationship management strategy. Many businesses collect and maintain extensive and detailed internal data pertaining to their consumers; however, a large portion of such data is too often not appropriately utilized or not used at all.

Accordingly, a need exists for a comprehensive consumer relationship management system that addresses multiple consumer issues. A need also exists for a comprehensive consumer relationship management system that can allow multiple consumers to interact and share information. Further, a need exists for a comprehensive consumer relationship management system that can process internal data to provide added value for consumers.

### SUMMARY OF THE INVENTION

The invention includes a system for comprehensive consumer relationship management. The system may include, for example, a host computer coupled to a network, a business metric calculating utility in communication with the host computer, the business metric calculating utility configured to receive a request for a business metric and calculate the business metric based upon public data and/or private data in accordance with the request, wherein the business metric calculating utility is coupled to a publicly available data store and a private data store; and, an extranet in communication with the host computer, the extranet configured to allow communication among a group of consumers, wherein the extranet is configured to allow access only to authorized users.

A system for calculating a business metric may comprise, for example: a host computer component coupled to a network, a publicly available data store and a private data store; a business metric calculating utility configured to receive a request for a business metric and calculate the business metric based upon at least one of: publicly available data and private data in accordance with a request; and wherein the business metric calculating utility is coupled to a publicly available data store and a private data store.

A method of comprehensive consumer relationship management may comprise, for example: receiving a request to access an extranet; authenticating the request; granting access to the extranet; receiving a request for a business metric; calculating the business metric in accordance with the request based upon public data and private data; wherein the public data and the private data is obtained from a publicly available data store and a private data store; and wherein the extranet is configured to allow communication among a group of consumers.

A method of using comprehensive consumer relationship management may comprise, for example: sending a request to access an extranet, wherein the request contains authenticating data; obtaining access to the extranet; sending a request for a business metric; receiving the business metric in accordance with the request, wherein the business metric is calculated based upon public data and private data; wherein the public data and the private data is obtained from a publicly available data store and a private data store; and wherein the extranet is configured to allow communication among a group of consumers.

### BRIEF DESCRIPTION OF THE DRAWINGS

FIG. 1 is a diagram of exemplary categories of consumers, in accordance with one embodiment of the present invention;

FIG. 2 is a diagram of exemplary subcategories of consumers, in accordance with one embodiment of the present invention;

FIG. 3 is a diagram of exemplary financial data used for model generation and validation, in accordance with one embodiment of the present invention;

FIG. 4 is a flowchart of an exemplary process for estimating the spend ability of a consumer, in accordance with one embodiment of the present invention;

FIG. 5 a program flow chart illustrating an exemplary embodiment for accessing a system, in accordance with one embodiment of the present invention;

FIG. 6 is a continuation of FIG. 5 illustrating a “Retrieval Request” of a system, in accordance with one embodiment of the present invention;

FIG. 7 is a continuation of FIG. 5 illustrating a “Fulfillment” of a system, in accordance with one embodiment of the present invention;

FIG. 8 is a diagram of some exemplary components of a system, in accordance with one embodiment of the present invention;

FIG. 9 is a diagram of an exemplary business metric calculating utility of a system, in accordance with one embodiment of the present invention;

FIG. 10 is a diagram of an exemplary extranet, in accordance with one embodiment of the present invention;

FIG. 11 is a diagram of an exemplary advertising agent, in accordance with one embodiment of the present invention;

### DETAILED DESCRIPTION

The detailed description of exemplary embodiments herein makes reference to the accompanying drawings, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment. For convenience, the present invention will be described in the context of a host business and the host business's consumers. In these examples, the consumers are also businesses themselves. Practitioners will appreciate that the present invention includes cases where the host business's consumers may not necessarily be businesses.

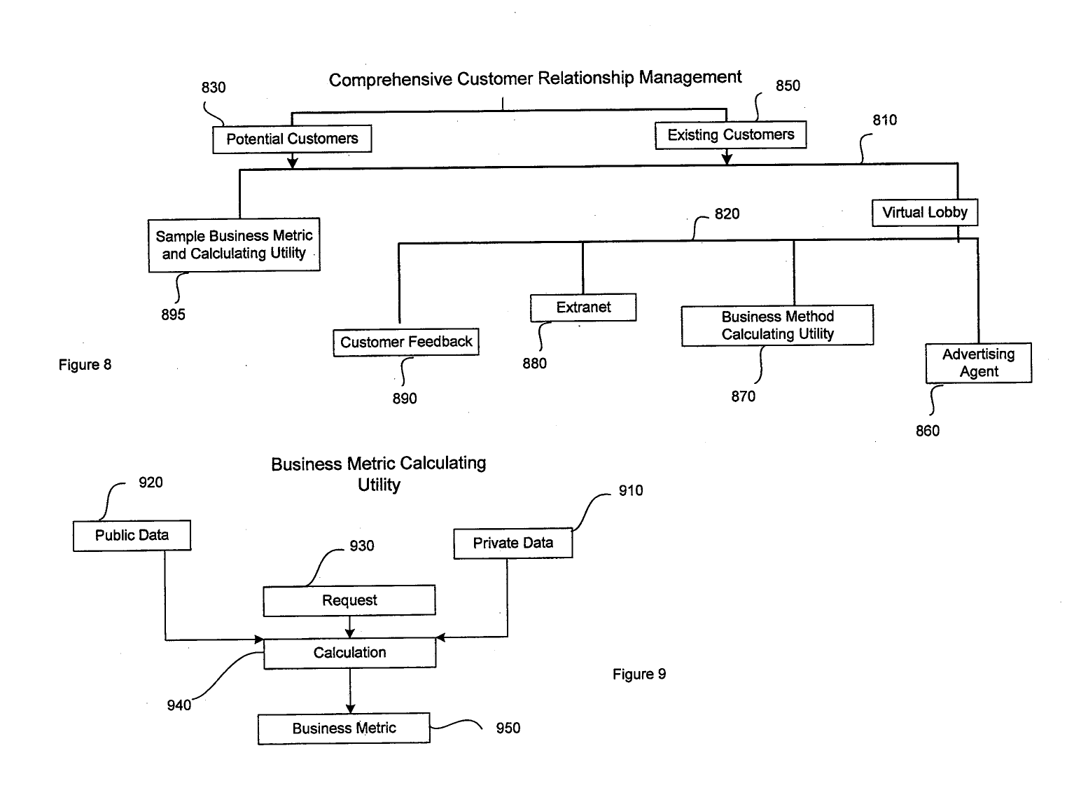

The present invention comprises a consumer relationship management system and method. More specifically, the present invention includes a system and method of providing consumers with electronic relationship management tools and customized data analysis. A comprehensive consumer relationship management system may comprise one or a combination of components, including a business metric calculating utility, an extranet, virtual advertising agent, a consumer feedback utility, a virtual lobby, a sample business metric calculating utility and a learning center. An example of one embodiment of the system in accordance with the present invention is depicted in FIG. 8.

The present invention also includes methods of comprehensive consumer relationship management. In various embodiments, the business metric calculating utility calculates business metrics based upon public data and private data. The business metrics may be calculated in accordance with a user request. For example, a business may desire to know business metrics such as where its consumers live or the average distance a consumer drives to their business or what other businesses its consumers frequent. The business metric calculating utility may obtain public data and private data, including internal data, to produce suitable answers to these questions. For example, the business metric calculating utility may be able to calculate the number of likely shoppers in a specific industry for a specific designated market area (“DMA”), standard metropolitan statistical area (“SMSA”) and/or a combination of zip codes in a specific mile radius. The resulting business metrics may be used to help businesses better market and cross-promote. For example, if a business finds many of its consumer travel a considerable distance to visit a store, the business may consider opening another store closer to its consumers. In another example, the business metric calculating utility may produce data regarding a business's competitors.

Public data 920 includes data, applications, and other information which is equally accessible by all or substantially all users of a public network. Public information includes, for example, credit bureau data (as described further below), the weather in New York as offered by a weather information website, the price of airfares from New York to Los Angeles as provided by a travel related site, demographic data by ZIP code as provided by the United States Census Bureau, and other such information. Public data may be maintained in a publicly available data store. A data store includes any system capable of storing and providing data. A data store may restrict access to certain data to only a limited number of authorized users.

Private data 910 includes information which is accessible by less than substantially all users. In one embodiment, the data is only accessible by one or more authorized users. Accessing private data usually requires a user to verify his or her identity in some way (e.g., by supplying a user name and password). Private data includes, for example, bank account records, 401(k) account information, purchasing records, and credit card balance information. Some private data may be accessible via an appropriate financial institution, bank and/or credit card website. Private data may be maintained in a private data store. Private data stores commonly restrict access to authorized users. Private data may include internal data and tradeline data.

Internal data includes any data pertaining to a particular consumer. The data may be possessed by a credit issuer. Internal data may be gathered before, during, or after a relationship between the credit issuer and the consumer. Such data may include consumer demographic data such as, for example, any data pertaining to a consumer. Consumer demographic data may include, for example, consumer name, address, telephone number, email address, employer and social security number. Consumer transactional data includes any data pertaining to the particular transactions in which a consumer engages, and the data may be limited to any given time period. Consumer transactional data may include, for example, transaction purchase amount, purchase time, and purchase vendor. Consumer payment data includes any data pertaining to a consumer's history of paying debt obligations. Consumer payment data may include, for example, consumer payment dates, payment amounts, balance amount, and credit limit.

Internal data may further comprise records of consumer service calls, complaints, requests for credit line increases, questions, and comments. A record of a consumer service call includes, for example, date of call, reason for call, and any transcript or summary of the actual call. Internal data may further comprise closed-loop data and open-loop data. Closed-loop data includes data obtained from a credit issuer's closed-loop transaction system. Open-loop data includes data obtained from a credit issuer's open-loop transaction system.

Credit bureau data includes any data retained by a credit bureau pertaining to a particular consumer. A credit bureau includes any organization that collects and/or distributes consumer data. A credit bureau may be a consumer reporting agency. Credit bureaus generally collect financial information pertaining to consumers. Credit bureau data may include, for example, consumer account data, credit limits, balances, and payment history. Credit bureau data may include credit bureau scores that reflect a consumer's creditworthiness. Credit bureau scores are developed from data available in a consumer's file such as, for example, the amount of lines of credit, payment performance, balance, and number of tradelines. Consumer data is used to model the risk of a consumer over a period of time using statistical regression analysis. In one embodiment, those data elements that are found to be indicative of risk are weighted and combined to determine the credit score. For example, each data element may be given a score, with the final credit score being the sum of the data element scores.

A consumer includes any person or entity that consumes items (e.g., goods and/or services). A consumer includes a customer or a prospective customer that may be interested in consuming items. A customer may include a consumer who engages in business with a particular business organization. A consumer also includes a merchant. A merchant includes business entities that are engaged in the buying and selling of goods and services. An entity may include any individual, consumer, customer, group, business, organization, government entity, transaction account issuer or processor (e.g., credit, charge, etc), merchant, consortium of merchants, customer, account holder, charitable organization, software, hardware, and/or any other entity.

A trade or tradeline includes a credit or charge vehicle typically issued to an individual consumer by a credit grantor. Types of tradelines include, for example, bank loans, credit card accounts, retail cards, personal lines of credit and car loans/leases.

Tradeline data includes the consumer's account status and activity such as, for example, names of companies where the consumer has accounts, dates such accounts were opened, credit limits, types of accounts, balances over a period of time and summary payment histories. Tradeline data is generally available for the vast majority of actual consumers. Tradeline data, however, typically does not include individual transaction data, which is largely unavailable because of consumer privacy protections. Tradeline data may be used to determine both individual and aggregated consumer spending patterns, as described herein.

A trade or tradeline includes a credit or charge vehicle issued to an individual consumer by a credit grantor. Types of tradelines include, for example, bank loans, transaction card accounts, retail cards, personal lines of credit and car loans/leases. Tradeline data describes the consumer's account status and activity, including, for example, names of companies where the consumer has accounts, dates such accounts were opened, credit limits, types of accounts, balances over a period of time and summary payment histories. Tradeline data is generally available for the vast majority of actual consumers. Tradeline data, however, may not include individual transaction data, which is largely unavailable because of consumer privacy protections. Tradeline data may be used to determine both individual and aggregated consumer spending patterns, as described herein.

Any transaction account or credit account discussed herein may include an account or an account number. An “account” or “account number”, as used herein, may include any device, code, number, letter, symbol, digital certificate, smart chip, digital signal, analog signal, biometric or other identifier/indicia suitably configured to allow the consumer to access, interact with or communicate with the system (e.g., one or more of an authorization/access code, personal identification number (PIN), Internet code, other identification code, and/or the like). The account number may optionally be located on or associated with a rewards card, charge card, credit card, debit card, prepaid card, telephone card, embossed card, smart card, magnetic stripe card, bar code card, transponder, radio frequency card or an associated account. The system may include or interface with any of the foregoing cards or devices, or a fob having a transponder and RFID reader in RF communication with the fob. Although the system may include a fob embodiment, the invention is not to be so limited. Indeed, the system may include any device having a transponder which is configured to communicate with RFID reader via RF communication. Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples can include watches, Internet enabled kitchen appliances, restaurant tables embedded with RF readers, wallets or purses with imbedded transponders, etc.

An extranet 1010 includes any system that allows authorized users to access a private or semi-private network. A private network is partially or fully controlled by one entity while a semi-private network may be partially or fully controlled by more than one entity. An extranet may be implemented using a virtual private network (VPN). Authorized users of the extranet may access data and resources after they authenticate their identity. In one example, an extranet may be hosted by one business that makes their consumers authorized users of the network. The host business may then share data and resources with the authorized users. In addition, authorized users may share data and resources with other authorized users

In various embodiments, the present invention includes a business metric calculating utility. A business metric calculating utility includes any system or method that calculates business metrics using a combination of private and public data. Business metrics include data that describe or measure a particular business or business process. Business metrics may relate to any aspect of a particular business. Business metrics also include data pertaining to the consumers of a particular business. Consumer data may include any data related to consumer demographics, consumer purchasing habits, consumer transaction data, consumer geographic data and any other data relating to a particular consumer and/or that particular consumer's spending history or interests. Consumer data may include data aggregated from more than one consumer. Consumer data may be derived from any data source, public or private. Consumer data includes internal data.

Referring to FIGS. 8 and 9, in various embodiments, a business metric calculating utility 870 may aggregate, model, and/or process data to provide business metrics 950 in accordance with a request 930. A business metric 950 may involve consumer spending capacity, as set forth below. A business metric calculating utility 870 may be configured to communicate with one or more data stores. A data store may contain public data 920, private data 910, or a combination thereof. Access to data in a data store may be restricted to authorized users. A request 930 for a business metric 950 is any request that calls for one or more business metrics. Requests include electronic requests. In various embodiments, a business metric calculating utility 870 may gather both public 920 and private data 910. The business metric calculating utility 870 may then apply one or more processing steps to calculate 940 one or more business metrics. The business metric calculating utility 870 may be presented in a report style, overlaid on a map, or displayed in any type of graphical presentation such as a bar graph or a pie chart.

The business metric calculating utility may be capable of customized, detailed data analysis that can be used in a variety of business applications. For example, in one embodiment, internal data is derived from a credit issuer who issues transaction cards to the public and the credit issuer's consumer is a merchant who accepts the credit issuer's transaction cards. In such an embodiment, for example, the business metric calculating utility may determine what percentage of the merchant's customers tip greater than a given percentage (e.g. 15%) at full service restaurants. Also, for example, when the merchant is a restaurant, the business metric calculating utility may determine what percentage of the merchant's customers tip greater than a given percentage (e.g. 15%) at both the merchant's place of business and also at competing restaurants in a given radius or postal code. In addition, for example, the business metric calculating utility may determine what percentage of the merchant's customers tip greater than a given percentage (e.g. 15%) at both the merchant's place of business but also at competing restaurants in a given radius or postal code. For the population determined in the preceding example, the business metric calculating utility may further determine the collective consumer spending capacity, as described herein below.

For example, in one embodiment, internal data is derived from a frequent customer card issuer that issues frequent customer cards to its customers. Frequent customer cards include cards and the associated records pertaining to frequent customers of a merchant. For example, many supermarket and warehouse merchants issue cards and associated accounts that track customer purchasing transactions. In various embodiments, the business metric calculating utility may determine, for example, the sales volume of a one or a group of merchant inventory items to a given set of customers given a particular weather pattern or time of year, such as, for example, the volume of beer sold to people who buy at least ten cases of beer per year on days when it rains.

For example, in one embodiment, internal data is derived from a bank that issues bank cards to its customers. Bank cards include transaction cards that enable a bank customer to access an account at, for example, an automatic teller machine. In various embodiments, the business metric calculating utility may determine, for example, the volume of large, time-consuming transactions at a given bank branch for a given time period of a day. Accordingly, a bank customer may locate less busy times to conduct business.

In various embodiments, business metric calculating utility may utilize charge volume analysis to determine windows of seasonal activity for a consumer's specific product(s) based on geography. For example, the business metric calculating utility may forecast real-time industry trends to determine a consumer's competitive position and gain intelligence in the marketplace. The business metric calculating utility may further refine a consumer's competitive position by integrating consumer-imputed financial information.

In various embodiments, business metric calculating utility may facilitate product placement and consumer inventory forecasts. The business metric calculating utility may produce metrics regarding the success of a product given where the product is placed within a consumer's physical location. Consumer inventory forecasts may be adjusted in accordance with this data, or other business metric data that pertains to projected sales volume.

In various embodiments, a virtual advertising agent 860 includes any system for enabling a business to better position their advertising. Many businesses contain advertising for business partners within their physical locations. Referring to FIG. 11, the virtual advertising agent may receive a request 1110, accept business data input 1120 and output advertising advice 1140. For example, a credit issuer may wish to promote itself within a particular business (e.g., restaurant). The virtual advertising agent 860 may model the interior of a restaurant and allow the owner of the restaurant to find places to place the credit issuer's advertisements. For example, a billfold may be branded with a credit issuer's logo or there may be branded stickers that depict when a restaurant is open and closed. A virtual advertising agent may provide assistance with placement of custom Point-of-Purchase (POP) materials in a consumer's locations to maximize value.

In various embodiments, a virtual advertising agent may be configured to allow a consumer to enroll into appropriate marketing programs based on the classification of the consumer. For example, a virtual advertising agent may enable coordination between consumers for cross-promotional activities. A virtual advertising agent may provide an electronic bulletin board to facilitate consumer cross-promotional activities such as proposing bundled usage promotions to solicit business. A bundled card usage promotion include promotions where several consumers would offer some promotional benefit if a particular consumer transacted with the consumers involved in the promotion. Also for example, a virtual advertising agent may create a consumer specific marketing calendar that reflects the business past trends

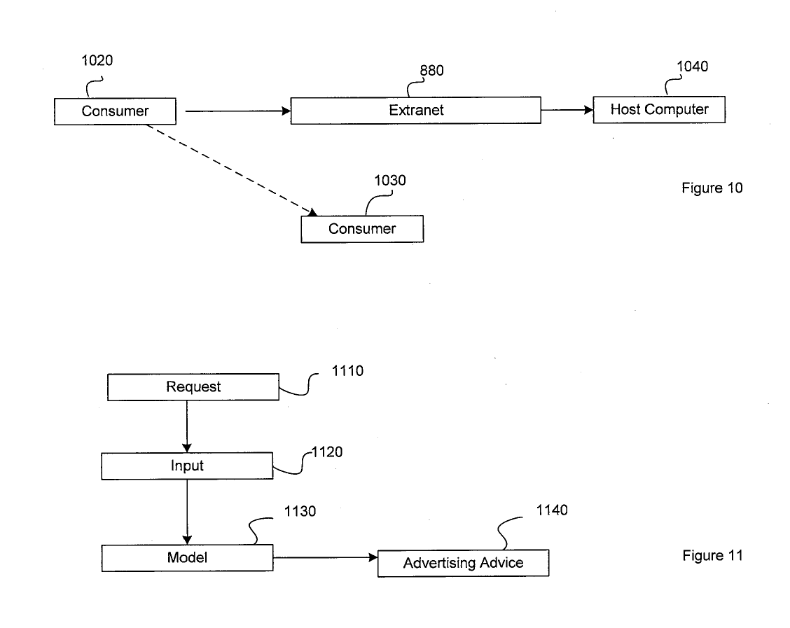

Referring to FIGS. 8 and 10, in various embodiments, an extranet 880 includes any system that enables a group of consumers 1020, 1030 to share data and access shared resources. In various embodiments, a host 1040 will host the extranet 880 and authorize on or more sets of consumers 1020, 1030. The consumers may then authenticate onto the extranet 880 and share data and resources of the host 1040, of other computer resources and/or share data and resources of each other. The extranet 880 can be used to manage a set of consumers of a particular business. In such embodiments, this business would be the host business. The data that is shared via the extranet 880 may include consumer data, internal data, public data and/or private data. The shared resources may be, for example, any type of service, web service or other electronic system. The extranet 880 may also be used to manage a consumer relationship. Consumers may deal with the host business primarily via the extranet 880. Any type of communication with the host business may take place via the extranet 880. Such matters include accounting inquiries, dispute resolution, account updates and modifications, account payments, accounts balance history. Dispute resolution may include dispute resolution processes between a credit issuer, a merchant, a cardmember and an acquirer as set forth herein.

The extranet 880 may also facilitate communications between consumers. Extranet consumers 1020, 1030 may be able to find complimentary businesses to partner with and target the same consumer base for solicitation. In addition, new business ideas can be shared. In various embodiments, the extranet 880 accessed via a VPN that in turn communicates with various shared resources. In various embodiments, the extranet 880 is implemented over secure web protocols or other communications discussed herein that, in turn, communicate with various shared resources. For example, an extranet may enable communications between cross-industry merchants that are compatible for joint marketing campaigns. For example, a seller of uniforms may communicate with buyers of uniforms, such as restaurants, law enforcement agencies, and automobile repair businesses.

Referring to FIG. 8, the consumer feedback utility 890 includes any mechanism that aggregates consumer feedback for a particular business. Consumer feedback includes ratings and opinions for a particular business. Feedback may be aggregated, for example, by a third party or may be created on various Internet bulletin board sites. Many sources of consumer feedback currently exist for various businesses. The consumer feedback utility 890 may contain logic that scans various websites and other data sources to find consumer feedback. Such feedback may then be aggregated in the consumer feedback utility 890. In various embodiments, the consumer feedback utility 890 communicates with an extranet. For example, a consumer feedback utility may aggregate consumer feedback such that feedback is linked to actual transactions. Feedback may be linked to transactions in a way that is specific, such as indicating a particular consumer gave feedback relating to a specific transaction. Feedback may be linked to transactions in a general manner, such as indicating a set of feedback items linked to a set of transactions that occurred in a given time period.

In various embodiments, the virtual lobby includes any mechanism that allows access to other component of a system. The virtual lobby may allow access to an extranet, business metrics calculating utility, virtual advertising agent, consumer feedback utility, or sample business metric calculating utility. For example, a virtual lobby may be a web page with links or access instructions to different components. For example, a virtual lobby includes access to consumer management information, account team contact information, servicing and operations contact information, online merchant services details and contact information, fraud prevention information, fraud training opportunities, operations opportunities and implementation instructions. Also for example, a virtual lobby may include automated email notifications and messaging when consumers request information or data.

In various embodiments, a sample business metrics calculating utility includes any business metrics calculating utility that only contains limited calculation options. A sample business metrics calculating utility may only allow a small number of calculations to be performed, or may be limited to certain types of calculations. For example, a sample business metrics calculating utility may only allow access to one or a small set of variables.

The present invention contemplates uses in association with web services, utility computing, pervasive and individualized computing, security and identity solutions, autonomic computing, commodity computing, mobility and wireless solutions, open source, biometrics, grid computing and/or mesh computing. Any of these components may be used alone or combined to perform functions described above.

A user may include any individual, business, entity, government organization, software and/or hardware that interact with a system to view customized search results relating to participating merchant web sites. A web client comprises any hardware and/or software suitably configured to facilitate input, receipt and/or review of information relating to merchants that are selected based on a search term entered into a search engine such as, for example, Google™, Yahoo™, MSN™, AOL™, and/or any other Internet-wide or web site centric search engines. A web client includes any device (e.g., personal computer) which communicates (in any manner discussed herein) via any network discussed herein. Such browser applications comprise Internet browsing software installed within a computing unit or system to conduct online transactions and/or communications. These computing units or systems may take the form of a computer or set of computers, although other types of computing units or systems may be used, including laptops, notebooks, hand held computers, personal digital assistants, set-top boxes, workstations, computer-servers, main frame computers, mini-computers, PC servers, pervasive computers, network sets of computers, and/or the like. Practitioners will appreciate that a web client may or may not be in direct contact with an application server. For example, a web client may access the services of an application server through another server, which may have a direct or indirect connection to an Internet server. For example, a web client may communicate with an application server via a load balancer.

As those skilled in the art will appreciate, a web client includes an operating system (e.g., Windows NT, 95/98/2000/CE/Mobile, OS2, UNIX, Linux, Solaris, MacOS, PalmOS, etc.) as well as various conventional support software and drivers typically associated with computers. A web client may include any suitable personal computer, network computer, workstation, minicomputer, mainframe or the like. A web client can be in a home or business environment with access to a network. In an exemplary embodiment, access is through a network or the Internet through a commercially available web-browser software package. A web client may implement security protocols such as Secure Sockets Layer (SSL) and Transport Layer Security (TLS). A web client may implement many application layer protocols including http, https, ftp, and sftp.

A web client may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network.

A web client may include any number of applications, code modules, cookies, and the like to facilitate the permissive search functionality as disclosed herein. In one embodiment, a web client includes a permissive search plug-in that is downloaded from an Internet server prior to performing a search. A permissive search plug-in may include any hardware and/or software suitably configured to detect when text is entered into a search box within a search interface and to submit the entered search text the application server for processing. In one embodiment, a permissive search plug-in retrieves and stores information relating to a user within a memory structure of a web client in the form of a browser cookie, for example. In another embodiment, permissive search plug-in retrieves information relating to user from an application server.

A firewall, as used herein, may comprise any hardware and/or software suitably configured to protect application server components from users of other networks. A firewall may reside in varying configurations including stateful inspection, proxy based, access control lists, and packet filtering among others. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

An Internet server may include any hardware and/or software suitably configured to facilitate communications between a web client and one or more application server components. Further, an Internet server may be configured to transmit data to a web client within markup language documents. As used herein, “data” may include encompassing information such as commands, queries, files, data for storage, and/or the like in digital or any other form. An Internet server may operate as a single entity in a single geographic location or as separate computing components located together or in separate geographic locations.

An Internet server may provide a suitable web site or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix, MySQL, InterBase, etc., may be used to provide an Active Data Object (ADO) compliant database management system. In one embodiment, the Apache web server is used in conjunction with a Linux operating system, a MySQL database, and/or the Perl, PHP, and Python programming languages.

Any of the communications, inputs, storage, databases or displays discussed herein may be facilitated through a web site having web pages. The term “web page” as it is used herein is not meant to limit the type of documents and applications that might be used to interact with the user. For example, a typical web site might include, in addition to standard HTML documents, various forms, Java applets, JavaScript, active server pages (ASP), common gateway interface scripts (CGI), extensible markup language (XML), dynamic HTML, AJAX (Asynchronous Javascript And XML), cascading style sheets (CSS), helper applications, plug-ins, and/or the like. A server may include a web service that receives a request from a web server, the request including a URL (http://yahoo.com/stockquotes/ge) and an IP address (123.56.789). The web server retrieves the appropriate web pages and sends the data or applications for the web pages to the IP address. Web services are applications that are capable of interacting with other applications over a communications means, such as the Internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference. For example, the any data input or output of a system may be presented on a web site via the above protocols. Examples of output include business metrics, customer feedback, and dispute resolution data.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external issuer systems for any of the purposes disclosed herein. In various embodiments, where more than one host computer components are dispersed across a network, middleware may be used to carry messages between components. These messages could be organized in any logical manner. WebSphere MQ™ (formerly MQSeries) by IBM, Inc. (Armonk, N.Y.) is an example of a commercially available middleware product. An Enterprise Service Bus (“ESB”) application is another example of middleware.

A user database may include any hardware and/or software suitably configured to facilitate storing identification, authentication credentials, user permissions, and user preferences. An Ad database stores data relating to merchants and merchant incentive programs. One skilled in the art will appreciate that the system may employ any number of databases in any number of configurations. Further, any databases discussed herein may be any type of database, such as relational, hierarchical, graphical, object-oriented, and/or other database configurations. Databases include Database Management Systems (“DBMS”). Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden) or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. The present invention contemplates various DBMS tuning steps to optimize DBMS performance. For example, frequently joined tables and other frequently used files such as indexes may be placed on separate file systems to reduce In/Out (“I/O”) bottlenecks.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the system by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments of system, the data can be stored without regard to a common format. However, in one exemplary embodiment of the invention, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand-alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand-alone device, the appropriate option for the action to be taken. The present invention contemplates a data storage arrangement wherein the header or trailer, or header or trailer history, of the data is stored on the transaction instrument in relation to the appropriate data.

One skilled in the art will also appreciate that, for security reasons, any databases, systems, devices, extranets, servers or other components of the present invention may consist of any combination thereof at a single location or at multiple locations, wherein each database or system includes any of various suitable security features, such as firewalls, access codes, encryption, decryption, compression, decompression, and/or the like.

The various system components discussed herein may include one or more of the following: a host server, a host computer or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; internal data; private data; public data; merchant data; financial institution data; and/or like data useful in the operation of the present invention. As those skilled in the art will appreciate, user computer may include an operating system (e.g., Windows NT, 95/98/2000, OS2, UNIX, Linux, Solaris, MacOS, etc.) as well as various conventional support software and drivers typically associated with computers. The computer may include any suitable personal computer, network computer, workstation, minicomputer, mainframe or the like. User computer can be in a home or business environment with access to a network. In an exemplary embodiment, access is through a network or the Internet through a commercially-available web-browser software package.

As used herein, the term “network” (or similar terms) shall include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, satellite communications, off-line communications, wireless communications, transponder communications, local area network (LAN), wide area network (WAN), virtual private network (“VPN”), networked or linked devices, keyboard, mouse and/or any suitable communication or data input modality. Moreover, although the invention is frequently described herein as being implemented with TCP/IP communications protocols, the invention may also be implemented using IPX, Appletalk, IP-6, NetBIOS, OSI, any tunneling protocol (e.g. IPsec), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards And Protocols (1998); Java 2 Complete, various authors, (Sybex 1999); Deborah Ray And Eric Ray, Mastering Html 4.0 (1997); And Loshin, Tcp/Ip Clearly Explained (1997) and David Gourley and Brian Totty, Http, The Definitive Guide (2002), the contents of which are hereby incorporated by reference. For example, a consumer may use a tunneling protocol to access an extranet. A consumer may use VPN software to access an extranet. A consumer may also use a web client to communicate with a host computer over the Internet using SSL or TLS. A host computer may access an extranet and serve data to a consumer via the web.

The invention may be described herein in terms of functional block components, screen shots, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and/or the like, which may carry out a variety of functions under the control of one or more microprocessors or other control devices. Similarly, the software elements of system may be implemented with any programming or scripting language such as C, C++, C#, Java, COBOL, assembly, PERL, PHP, awk, python, Visual Basic, SQL Stored Procedures, PL/SQL, any UNIX shell script, extensible markup language (XML), with the various algorithms being implemented with any combination of data structures, objects, processes, routines or other programming elements. Further, it should be noted that the present invention may employ any number of conventional techniques for data transmission, signaling, data processing, network control, and/or the like. Still further, system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As will be appreciated by one of ordinary skill in the art, the system may be embodied as a customization of an existing system, an add-on product, upgraded software, a stand alone system, a distributed system, a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Practitioners will appreciate that there are a number of methods for displaying data within a browser-based document. Data may be represented as standard text or within a fixed list, scrollable list, drop-down list, editable text field, fixed text field, pop-up window, and/or the like. Likewise, there are a number of methods available for modifying data in a web page such as, for example, free text entry using a keyboard, selection of menu items, check boxes, option boxes,

While the steps outlined herein represent a specific embodiment of the invention, practitioners will appreciate that there are any number of computing algorithms and user interfaces that may be applied to create similar results. The steps are presented for the sake of explanation only and are not intended to limit the scope of the invention in any way.

In various embodiments, the business metric calculating utility may also be able to produce a model of consumer spending capacity. To model consumer spending capacity, consumer spend may be determined over previous periods of time (sometimes referred to herein as the consumer's size of wallet) from tradeline data sources. The share of wallet by tradeline or account type may also be determined. The size of wallet (“SoW”) is represented by a consumer's or business' total aggregate spending and the share of wallet represents how the consumer uses different payment instruments. Methods and apparatus for calculating the size of wallet have been disclosed in U.S. patent application Ser. No. 11/169,588 which was published with publication number 2006-0242046 A1, the disclosure of which is hereby incorporated by reference in its entirety. Exemplary size of wallet determinations will now be discussed in detail.

Consumer panel data measures consumer spending patterns from information that is provided by, typically, millions of participating consumer panelists. Exemplary consumer panel data is available through various consumer research companies, such as comScore Networks, Inc. of Reston, Va. Consumer panel data may include individual consumer information such as, for example, credit risk scores, credit card application data, credit card purchase transaction data, credit card statement views, tradeline types, balances, credit limits, purchases, balance transfers, cash advances, payments made, finance charges, annual percentage rates and fees charged. Such individual information from consumer panel data, however, may be limited to those consumers who have participated in the consumer panel, and so such detailed data may not be available for all consumers. One skilled in the art will appreciate that the use of the term “computer” or any similar term includes any type of hardware or software in which a host is able to acquire information. Such computers may include personal computers, personal digital assistants, biometric devices, transaction account devices, loyalty accounts and/or the like.

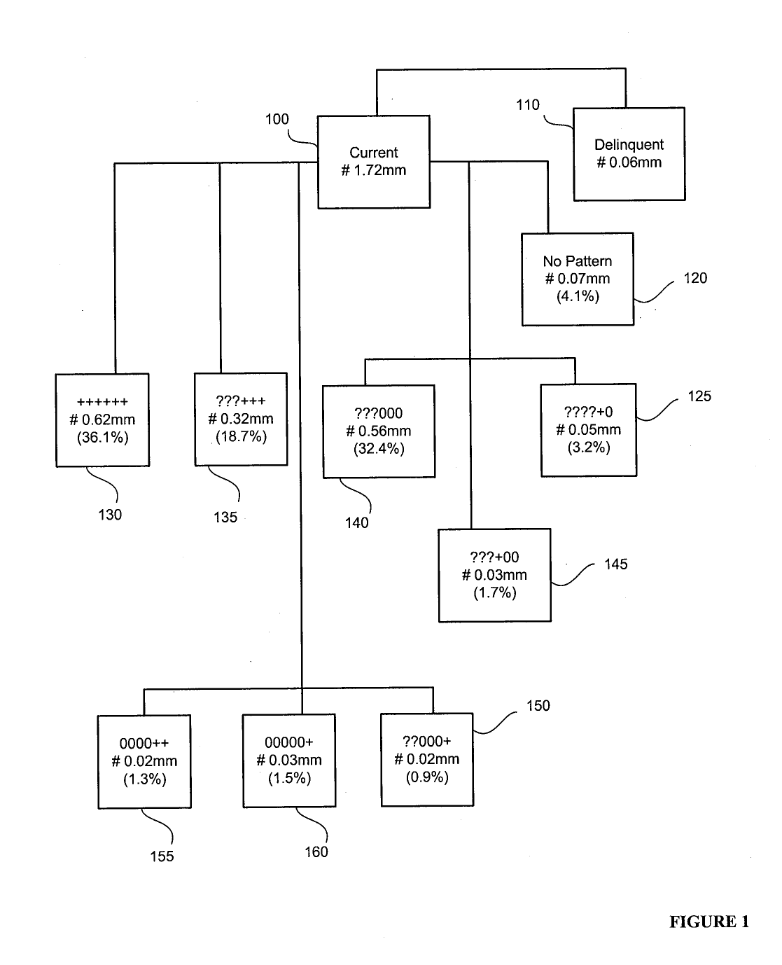

As shown in FIG. 1, a population of consumers for which individual and/or aggregated data has been provided may be divided into two general categories for analysis, for example, those that are current on their credit accounts (representing 1.72 million consumers in the exemplary data sample size of 1.78 million consumers) and those that are delinquent (representing 0.06 million of such consumers). In one embodiment, delinquent consumers may be discarded from the populations being modeled.

In further embodiments, the population of current consumers is subdivided into a plurality of further categories based on the amount of balance information available and the balance activity of such available data. In the example shown in FIG. 1, the amount of balance information available is represented by a string of ‘+’ ‘0’ and ‘?’ characters. Each character represents one month of available data, with the rightmost character representing the most current months and the leftmost character representing the earliest month for which data is available. In the example provided in FIG. 1, a string of six characters is provided, representing the six most recent months of data for each category. The “+” character represents a month in which a credit account balance of the consumer has increased. The “0” character may represent months where the account balance is zero. The “?” character represents months for which balance data is unavailable. Also provided in FIG. 1 is number of consumers that fall into each category and the percentage of the consumer population they represent in that sample.

In further embodiments, only certain categories of consumers may be selected for modeling behavior. The selection may be based on those categories that demonstrate increased spend on their credit balances over time. However, it should be readily appreciated that other categories can be used. FIG. 1 shows an example of two categories of selected consumers for modeling (+++++, ???+++). These groups show the availability of at least the three most recent months of balance data and that the balances increased in each of those months.

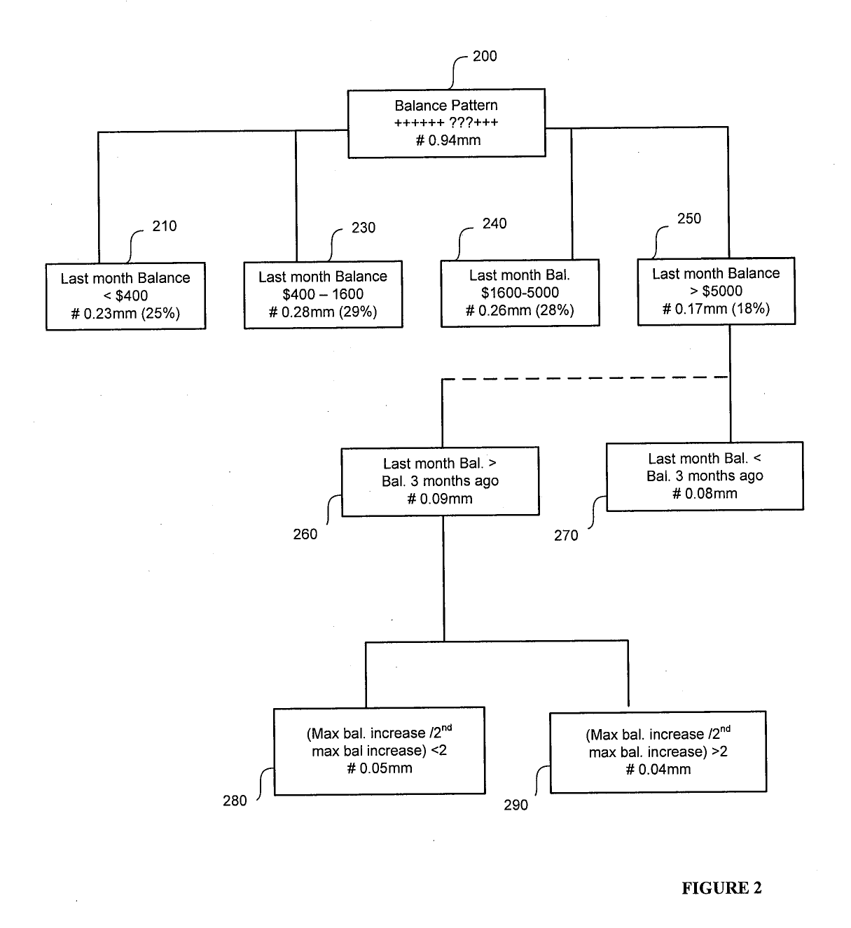

Turning now to FIG. 2, which shows sub-categorization of the two categories (+++++, ???+++) that are selected for modeling. In the embodiment shown, the sub-categories may include: consumers having a most recent credit balance less than $400; consumers having a most recent credit balance between $400 and $1600; consumers having a most recent credit balance between $1600 and $5000; consumers whose most recent credit balance is less than the balance of, for example, three months ago; consumers whose maximum credit balance increase over, for example, the last twelve months divided by the second highest maximum balance increase over the same period is less than 2; and consumers whose maximum credit balance increase over the last twelve months divided by the second highest maximum balance increase is greater than 2. It should be readily appreciated that other subcategories can be used. Each of these subcategories is defined by their last month balance level. The number of consumers from the sample population (in millions) and the percentage of the population for each category are also shown in FIG. 2.

There may be a certain balance threshold established, wherein if a consumer's account balance is too high, their behavior may not be modeled, since such consumers are less likely to have sufficient spending ability. In another embodiment, consumers having balances above such threshold may be sub-categorized yet again, rather than completely discarded from the sample. In the example shown in FIG. 2, the threshold value may be $5000, and only those having particular historical balance activity may be selected, i.e. those consumers whose present balance is less than their balance three months earlier, or whose maximum balance increase in the examined period meets certain parameters. Other threshold values may also be used and may be dependent on the individual and aggregated consumer data provided.

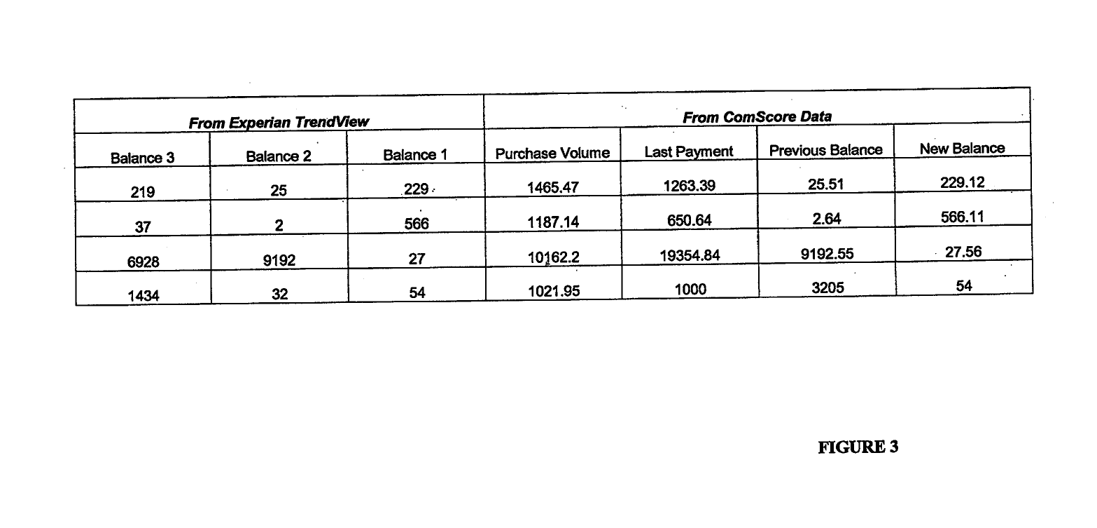

The models generated may be derived, validated and refined using tradeline and consumer panel data. An example of tradeline data 500 from Experian and consumer panel data 502 from comScore is represented in FIG. 3. Each row of the data represents the record of one consumer and thousands of such records may be provided at a time. The statement shows the point-in-time balance of consumers accounts for three successive months (Balance 1, Balance 2 and Balance 3). The data shows each consumer's purchase volume, last payment amount, previous balance amount and current balance. Such information may be obtained, for example, by page scraping the data (in any of a variety of known manners using appropriate application programming interfaces) from an Internet web site or network address at which the data is displayed.

Furthermore, the data may be matched by consumer identity and combined by one of the data providers or another third party independent of the financial institution. Validation of the models using the combined data may then be performed, and such validation may be independent of consumer identity.

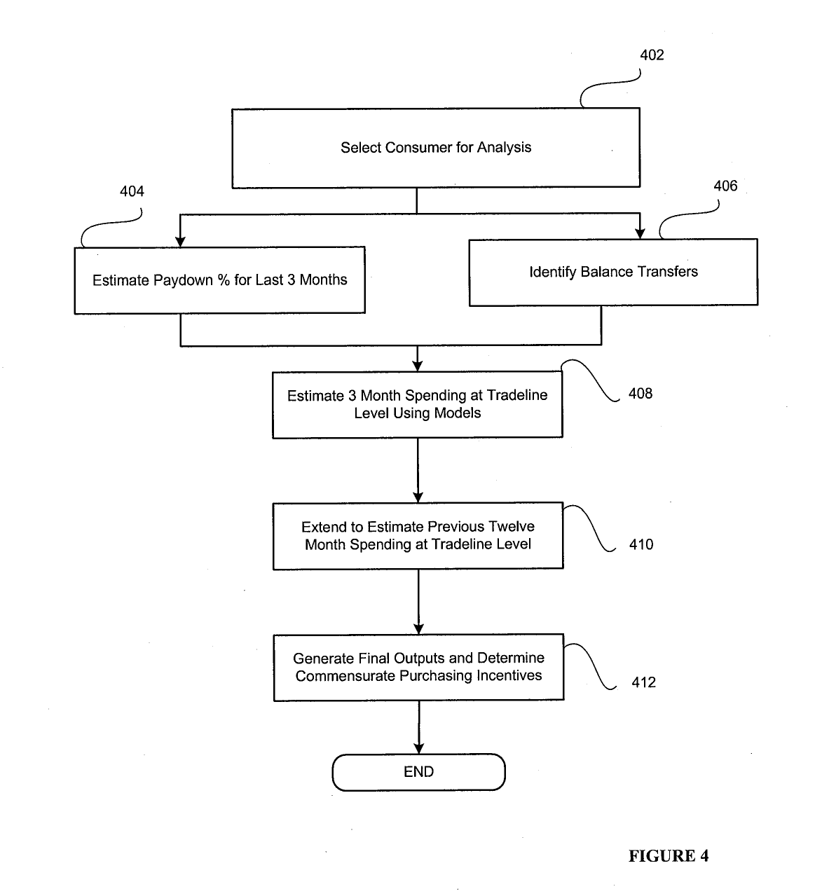

Turning now to FIG. 4, an exemplary process for estimating the size of an individual consumer's spending wallet is shown. Upon completion of the modeling of the consumer categories above, the process commences with the selection of individual consumers or prospects to be examined (step 402). An appropriate model derived for each category will then be applied to the presently available consumer trade line information in the following manner to determine, based on the results of application of the derived models, an estimate of a consumer's size of wallet. Each consumer of interest may be selected based on their falling into one of the categories selected for modeling described above, or may be selected using any of a variety of criteria.

The process continues to step 404 where, for a selected consumer, a paydown percentage over a previous period of time is estimated for each of the consumer's credit accounts. In one embodiment, the paydown percentage is estimated over the previous three-month period of time based on available tradeline data, and may be calculated according to the following formula:

Pay-down %=(The sum of the last three months payments from the account)/(The sum of three month balances for the account based on tradeline data).

The paydown percentage may be set to, for example, 2%, for any consumer exhibiting less than a 5% paydown percentage, and may be set to 100% if greater than 80%, as a simplified manner for estimating consumer spending behaviors on either end of the paydown percentage scale.

Consumers that exhibit less than a 50% paydown during a three month period may be categorized as revolvers, while consumers that exhibit a 50% paydown or greater may be categorized as transactors. These categorizations may be used to initially determine what, if any, purchasing incentives may be available to the consumer, as described later below.

The process then continues to step 406, where balance transfers for a previous period of time are identified from the available tradeline data for the consumer. Although tradeline data may reflect a higher balance on a credit account over time, such higher balance may simply be the result of a transfer of a balance into the account, and are thus not indicative of a true increase in the consumer's spending. It is difficult to confirm balance transfers based on tradeline data since the information available is not provided on a transaction level basis. In addition, there are typically lags or absences of reporting of such values on tradeline reports.

Nonetheless, marketplace analysis using confirmed consumer panel and internal consumer financial records has revealed reliable ways in which balance transfers into an account may be identified from imperfect individual tradeline data alone. Three exemplary reliable methods for identifying balance transfers from credit accounts, each which is based in part on actual consumer data sampled, are as follows.

It should be readily apparent that the formulas in the form recited above are not necessary for all embodiments of the present process and may vary based on the consumer data used to derive them.

A first rule identifies a balance transfer for a given consumer's credit account as follows.

The month having the largest balance increase in the tradeline data, and which satisfies the following conditions, may be identified as a month in which a balance transfer has occurred:
The maximum balance increase is greater than twenty times the second maximum balance increase for the remaining months of available data;
The estimated pay-down percentage calculated at step 406 above is less than 40%; and
The largest balance increase is greater than $1000 based on the available data.

A second rule identifies a balance transfer for a given consumer's credit account in any month where the balance is above twelve times the previous month's balance and the next month's balance differs by no more than 20%.

A third rule identifies a balance transfer for a given consumer's credit account in any month where:
the current balance is greater than 1.5 times the previous month's balance;
the current balance minus the previous month's balance is greater than $4500; and
the estimated pay-down percent from step 406 above is less than 30%.

The process then continues to step 408, where consumer spending on each credit account is estimated over the next, for example, three month period. In estimating consumer spend, any spending for a month in which a balance transfer has been identified from individual tradeline data above is set to zero for purposes of estimating the size of the consumer's spending wallet, reflecting the supposition that no real spending has occurred on that account. The estimated spend for each of the three previous months may then be calculated as follows:

Estimated spend=(the current balance−the previous month's balance+(the previous month's balance*the estimated pay-down % from step 404 above).

The exact form of the formula selected may be based on the category in which the consumer is identified from the model applied, and the formula is then computed iteratively for each of the three months of the first period of consumer spend.

Next, at step 410, the estimated spend is then extended over, for example, the previous three quarterly or three-month periods, providing a most-recent year of estimated spend for the consumer.

Finally, at step 412, the data output from step 410, in turn may be used to generate a plurality of final outputs for each consumer account. These may be provided in an output file that may include a portion or all of the following exemplary information, based on the calculations above and information available from individual tradeline data:

(i) size of previous twelve month spending wallet; (ii) size of spending wallet for each of the last four quarters; (iii) total number of revolving cards, revolving balance, and average pay down percentage for each; (iv) total number of transacting cards, and transacting balances for each; (v) the number of balance transfers and total estimated amount thereof; (vi) maximum revolving balance amounts and associated credit limits; and (vii) maximum transacting balance and associated credit limit.

After step 412, the process may end with respect to the examined consumer. It should be readily appreciated that the process may be repeated for any number of current consumers or consumer prospects.

Such estimated spending may be calculated in a rolling manner across each previous three month (quarterly) period. For example, spending in each of a first three months of a first quarter may be calculated based on balance values, the category of the consumer based on the above referenced consumer categorization spending models and the formulas used in steps 404 and 406. Calculation may continue every three months, using the previous three months' data as an input.

It should be readily appreciated that as the rolling calculations proceed, the consumer's category may change based on the outputs that result, and therefore, different formula corresponding to the new category may be applied to the consumer for different periods of time. The rolling manner described above maximizes the known data used for estimating consumer spend in a previous twelve month period. Based on the final output generated for the consumer, commensurate purchasing incentives may be identified and provided to the consumer, for example, in anticipation of an increase in the consumer's purchasing ability as projected by the output file. In such cases, consumers of good standing, who are categorized as transactors with a projected increase in purchasing ability, may be offered a lower financing rate on purchases made during the period of expected increase in their purchasing ability, or may be offered a discount or rebate for transactions with selected merchants during that time.

It should be readily appreciated that as the rolling calculations proceed, the consumer's category may change based on the outputs that result. Therefore, different formula corresponding to the new category may be applied to the consumer for different periods of time. The rolling manner described above maximizes the known data used for estimating consumer spend in a previous twelve month period Based on the final output generated for the consumer, commensurate purchasing incentives may be identified and provided to the consumer, for example, in anticipation of an increase in the consumer's purchasing ability as projected by the output file. In such cases, consumers of good standing, who are categorized as transactors with a projected increase in purchasing ability, may be offered a lower financing rate on purchases made during the period of expected increase in their purchasing ability, or may be offered a discount or rebate for transactions with selected merchants during that time.

In another example, and in the case where a consumer is a revolver, a consumer with a projected increase in purchasing ability may be offered a lower annual percentage rate on balances maintained on their credit account. Other like promotions and enhancements to consumers' experiences are well known and may be used within the processes disclosed herein.

Prospective consumer populations used for modeling and/or later evaluation may be provided from any of a plurality of available marketing groups, or may be culled from credit bureau data, targeted advertising campaigns or the like. Testing and analysis may be continuously performed to identify the optimal placement and required frequency of such sources for using the size of spending wallet calculations. The processes described herein may also be used to develop models for predicting a size of wallet for an individual consumer in the future.

Institutions adopting the processes disclosed herein may expect to more readily and profitably identify opportunities for prospect and consumer offerings, which in turn provides enhanced experiences across all parts of a consumer's lifecycle. In the case of a credit provider, accurate identification of spend opportunities allows for rapid provisioning of card member offerings to increase spend that, in turn, results in increased transaction fees, interest charges and the like. The careful selection of consumers to receive such offerings reduces the incidence of fraud that may occur in less disciplined cardmember incentive programs. The reduced incidence of fraud, in turn, reduces overall operating expenses for institutions.

As mentioned above, the process described may also be used to develop models for predicting a size of wallet for an individual consumer in the future. The capacity a consumer has for spending in a variety of categories is the share of wallet.

The model used to determine share of wallet for particular spend categories using the processes described herein is the share of wallet (“SoW”) model. The SoW model provides estimated data and/or characteristics information that is more indicative of consumer spending power than typical credit bureau data or scores. The SoW model may output, with sufficient accuracy, data that is directly related to the spend capacity of an individual consumer. One of skill in the art will recognize that any one or combination of the following data types, as well as other data types, may be output by the SoW model without altering the spirit and scope of the present invention.

The size of a consumer's twelve-month spending wallet is an example output of the SoW model. A consumer's twelve-month spending wallet may be output as an actual or rounded dollar amount. The size of a consumer's spending wallet for each of several consecutive quarters, for example, the most recent four quarters, may also be output.

The SoW model output may include the total number of revolving cards held by a consumer, the consumer's revolving balance, and/or the consumer's average pay-down percentage of the revolving cards. The maximum revolving balance and associated credit limits can be determined for the consumer, as well as the size of the consumer's revolving spending.

Similarly, the SoW model output may include the total number of a consumer's transaction cards and/or the consumer's transaction balance. The SoW model may additionally output the maximum transacting balance, the associated credit limit, and/or the size of transactional spending of the consumer.

These outputs, as well as any other outputs from the SoW model, may be appended to data profiles of a company's consumers and prospects. The output enhances the company's ability to make decisions involving prospecting, new applicant evaluation, and consumer relationship management across the consumer lifecycle. The SoW score can focus, for example, on total spend, transaction account spend and/or a consumer's spending trend.

Using the processes described above, balance transfers are factored out of a consumer's spend capacity. Further, when correlated with a risk score, the SoW score may provide more insight into behavior characteristics of relatively low-risk consumers and relatively high-risk consumers.

The SoW score may be structured in one of several ways. For instance, the score may be a numeric score that reflects a consumer's spend in various ranges over a given time period, such as the last quarter or year. As an example, a score of 5000 might indicate that a consumer spent between $5000 and $6000 in the given time period.

The score may include a range of numbers or a numeric indicator, such as an exponent, that indicates the trend of a consumer's spend over a given time period. For example, a trend score of +4 may indicate that a consumer's spend has increased over the previous 4 months, while a trend score of −4 may indicate that a consumer's spend has decreased over the previous 4 months.

In addition to determining an overall SoW score, the SoW model outputs may each be given individual scores and used as attributes for consideration in credit score development by, for example, traditional credit bureaus. As discussed above, credit scores are traditionally based on information in a consumer's credit bureau file. The business metric calculating utility may produce metrics, including one of more SoW outputs, if a user request so instructs.

In various embodiments, the present invention includes methods of using an extranet to facilitate consumer relationship management. The extranet may facilitate any business process between two or more entities. Entire business processes may be conducted entirely electronically and in real-time.

One frequent business process that may conducted within an extranet is that of dispute resolution. A system and method for facilitating the handling of a dispute has been disclosed in U.S. patent application Ser. No. 09/537,506 which was issued as U.S. Pat. No. 7,249,113 B1 on Jul. 24, 2007, the disclosure of which is hereby incorporated by reference in its entirety.

With increasing popularity, consumers worldwide are purchasing goods and services on credit. For many purchasers, the most convenient form of payment is a plastic card with a magnetic stripe, an embossed account number and/or a smart chip called a credit card (hereafter “card” or “cards”).

Cards may be used at service establishments (S/Es) (e.g., automated teller machines (ATM), point of sale (POS), and instances when no card is required during the transaction such as purchases over the Internet) that have entered into agreements with an Acquirer for the S/E to accept cards from cardmembers to charge purchases of goods and services or for cash access. An Acquirer may be, for example, a nonfinancial or financial entity that specializes in the marketing, installation and support of POS card acceptance at S/Es. Acquirers generally negotiate a contract with the S/E to accept a brand of cards (e.g., AMERICAN EXPRESS®, VISA®, MasterCard®, DISCOVER CARD®).

Card Issuers are typically banks and other financial organizations operating under the regulations of a card issuing association or entity. The cardmember enters into an agreement and establishes a card account with the Issuer. The Issuer's name generally appears on the card and cardmember's payments are typically sent to that Issuer.

Occasionally cardmembers may receive unsatisfactory goods or services from the S/E, be involved with a dispute over price with the S/E, or the S/E may have failed to comply with the regulations and/or terms of its card acceptance agreement with the Acquirer. Typically the cardmember then notifies the Issuer about the dispute with the S/E, which prompts the Issuer to begin a dispute resolution process with the Acquirer on behalf of the cardmember.

In order to substantiate the dispute claim of the cardmember, the Issuer may first make a “retrieval request” to the Acquirer. The receipt for a cardmember's purchase or credit transaction containing the details of any transaction carried out at the S/E is called the record of charge (ROC). A retrieval request may include a request for either an original ROC, a legible reproduction of the ROC, or any other transactional documentation from the Acquirer. The documentation supplied by the Acquirer in reply to a retrieval request is called “fulfillment.”

A typical “chargeback” is a reversal of a credit transaction which is “charged-back” to the Acquirer from the Issuer. The Acquirer may refute the chargeback and process a “second presentment” to the Issuer with additional documentation. A “final chargeback” by the Issuer to the Acquirer occurs if the Issuer refutes the “second presentment” by providing additional documentation. The aforementioned dispute handling process between Issuers and Acquirers may occur in a process implemented by a computer such that the efficiency of the process increases.

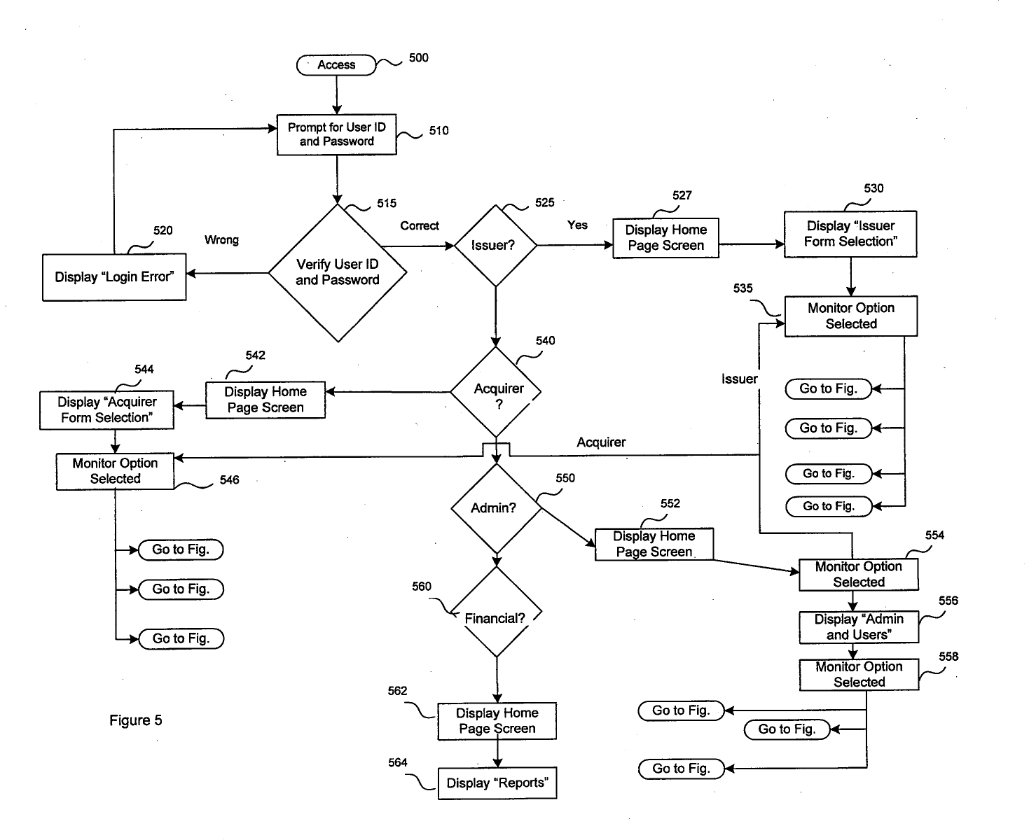

FIG. 5 summarizes the steps performed by the computer system while executing one exemplary method of the present invention. These steps are merely illustrative and can be modified or adapted. Users, which may include Issuers, Acquirers, administrative and financial personnel, complete a User ID request and receive a User ID and password. User IDs and passwords are unique to specific users and are stored on the server database. A first end-user, for example an Issuer, accesses the web site (step 500) by any known Internet browser means.

After accessing the web site, the system stored on a server is configured to prompt the end-user for a User ID and password. Once the Issuer, or any user, has been authenticated by matching the entered User ID and password with a database located on the server (step 515), the Issuer will be presented with only those functions the Issuer is authorized to use (e.g., Issuers may be presented with only Issuer functions and Acquirers may be presented with only Acquirer functions). If the User ID and password do not correspond to a known (stored) User ID and password, the system displays a “Logon Error” message (520) and returns to the previous screen (step 510).

The system is configured to respond to the entry of the User ID and password with a set of queries to determine what type of user has been verified (e.g., Issuer, Acquirer, administration, financial). If the entered User ID and password correspond to an Issuer (step 525), the system causes the virtual lobby to be displayed.

If the entered User ID and password do not correspond to an Issuer, the system is configured to query if the entered data is for an Acquirer (step 540). In a similar manner as described for the Issuer, if the user is an Acquirer, the home page is displayed (step 542) and the system causes the display “Acquirer Form Selection” (step 544). Because the User ID and password are unique for each type of exemplary user (Issuer, Acquirer, administration, financial), the system is configured to determine what type of user is accessing and to continue if the entered data is for neither an Issuer or an Acquirer.

Administrative personnel (“AP”) perform such functions as issuing User IDs and passwords or any other administrative function which may be needed to provide “system service” to other users (e.g., add, delete, modify User IDs). If the entered User ID and password correspond to AP (step 550), the home page screen is displayed (step 552). It is desirable to give AP access rights to both Issuer, Acquirer and administrative functions and/or forms. Often, AP initiate a dispute or respond to a dispute instead of the Issuer or Acquirer. In other words, AP can access the forms available to an Issuer or an Acquirer and complete the forms on behalf of and at the direction of the Issuer or Acquirer. AP are given an option (step 554) from the home page screen to choose “Dispute Handling,” which gives AP the option of either Issuer forms or Acquirer forms, or to choose “Admin.” The “Admin” option causes the system to display the “Administration” screen which contains a list of all active and inactive users that have been assigned a User ID and password (step 556). The AP can choose a function from the “Administration” screen and the option is monitored by the system (step 558).

In the exemplary embodiment as described above, if the entered User ID and password does not correspond to any of the above types of users, the user is financial personnel (FP) (step 560). (Step 515 verifies that the User ID and password corresponds to a single type of user; only one user type is remaining). The FP perform settlement and funds exchange between the other users, namely Issuers and Acquirers. The system causes the home page to display (step 562). FP may be given limited access to reporting functions and the like, or similar functions which enable FP to settle funds. For this reason, FP may be given a single option to choose from off the home page. In one exemplary embodiment, the option is reporting and the system causes the display “Reports” (step 564).

Upon display of the “Form Selection” screen for either the Issuer or the Acquirer, the system monitors the response of the user for one of the options presented on the display (step 535) (step 546). In an exemplary embodiment, the system causes a display which allows the user to choose from dispute handling forms.

In practice, the Issuer is typically notified by a cardmember that there is an unresolved dispute with the S/E, for example, the cardmember may have received unsatisfactory goods or services or there may be a discrepancy in the price paid. The Issuer then begins the dispute handling process with the Acquirer on behalf of the cardmember. Once the Issuer is authenticated by the system, and the “Issuer Form Selection” menu is displayed, the Issuer may begin the process by completing an on-line retrieval request form.

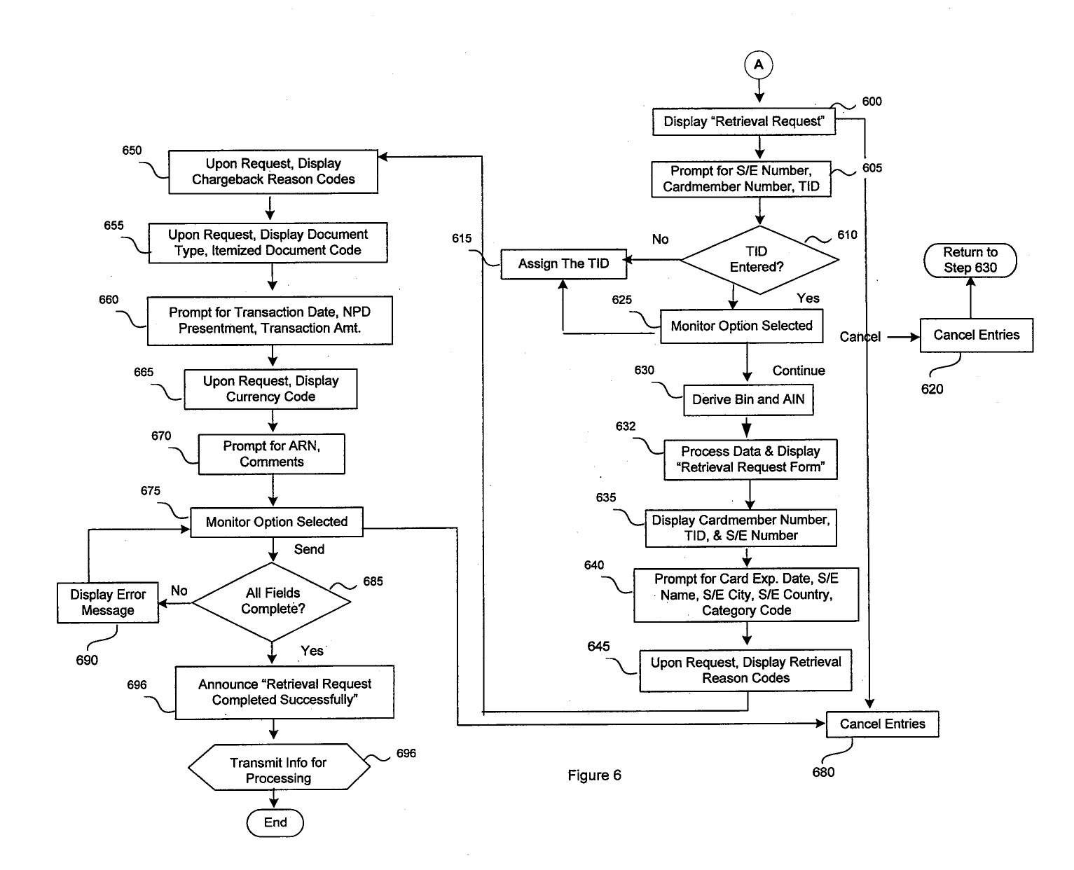

Referring to FIG. 6, upon selection of “Retrieval Request,” the system causes the display “Retrieval Request” (step 600). Throughout the form, the system prompts the Issuer to enter data with respect to the unresolved dispute. The Issuer is asked to provide information which will help the Acquirer to recognize the disputed matter and to promote a fast response time. The requested data can vary according to the dispute application, however, in the sake of brevity, the present invention is described with respect to one exemplary application for Issuers and Acquirers. The Issuer is asked to provide the S/E number, cardmember number and TID (transaction identifier which consists of an unique alphanumeric sequence) (step 605). The system identifies whether a TID was entered by the Issuer (step 610) and if not, the system will automatically assign the TID from a stored algorithm (step 615). The Issuer is next presented with an option which is monitored by the system (step 625). At this point, the Issuer may choose “cancel,” which deletes the entries, cancels the current process (step 620) and returns the application to the previous screen (step 530).

Should the Issuer choose “continue”, the system begins processing the entered data which includes, but not limited to, deriving both the BIN (bank identification number) from the entered cardmember number and the AIN (acquirer identification number) by matching the S/E number with a table stored on a server database (step 630). The system causes a display of “Retrieval Request Form” (step 632) and displays the previously entered data (step 635). The Issuer is asked to provide additional information about the card and S/E which can include, card expiration date, S/E's name, city and country, and the merchant category code (step 640). The merchant category code classifies the type of business product or service associated with the transaction. In a preferred embodiment, the system may suitably offer a menu of merchant category codes to be selected by the Issuer.

To facilitate data entry, a plurality of menu options, such as, for example, a “drop-down menu,” may be stored on the server. The Issuer can choose to have the menu options displayed by “clicking” the appropriate on-screen button. For instance, the Issuer may choose from a “drop-down menu” containing a list of retrieval reason codes (step 645). A drop-down menu may offer the Issuer with a list of pre-written options from which the Issuer may simply “click-on” one of the options. The pre-written option may save the Issuer entry time and further promotes fast and uniform data entry. Examples of retrieval reason codes which may display, include “the cardmember does not recognize this transaction” or “the cardmember requests a copy of the transaction for his personal records.” Each retrieval reason code may be suitably associated with process timeframes.

A similar drop-down menu may prompt the user to choose from a list of chargeback reason codes (step 650). “Chargeback” is the term used in the industry to indicate a reversal of a credit transaction which is charged-back to the Acquirer. Chargebacks and chargeback codes may include “goods and services not received” “missing or invalid signature,” and “currency discrepancy.” The chargeback codes may be associated with process timeframes and indexed by the system (similar to the retrieval reason codes). Additionally, a drop-down menu option may prompt the Issuer to choose from a list of supporting documentation codes (step 655). The Issuer may desire a copy of a receipt of the cardmember's purchase, or the credit transaction data containing the details of the transaction carried out at the S/E.

Next, the system may prompt the Issuer for entry of the transaction date, the network processing date of the transaction (NPD) and the transaction monetary amount (step 660). The Issuer may choose from a drop-down menu containing a list of currency codes (step 665). The currency code may denote the country of origin for the original transaction. The Issuer may also be asked to enter the ARN (acquirer reference number) and any comments the Issuer may wish to include with the retrieval request form (step 670).

After the Issuer enters the appropriate data requested above, the system monitors the next option selected by the user (step 675). If the Issuer wants to cancel the current process, the Issuer may choose the “cancel” option and the system cancels the entries (step 680) and returns to the previous screen (step 600). Once satisfied with the entries, the Issuer may choose the “send” option. The system then verifies that all requested fields are complete (step 685). If field items are missing and/or contain invalid data (e.g., numeric data where alpha data is required), the system causes an error message display (step 690). If all fields are complete, the system may announce “Retrieval Request Completed Successfully” (step 695) and may transmit the completed form to the server for processing (step 696).

As detailed earlier, the displayed “Form Selection” screen depends upon the User ID and password which are entered. Each user may be presented with only those functions which the user is authorized to use. From the “Form Selection” screen, users (e.g., Issuers and Acquirers) may also be presented with an “Inbox” function. The inbox may display all the forms routed by the server to the user from other users wishing to initiate or respond to a dispute. For instance, the retrieval request detailed above may be routed by the server to the Acquirer's inbox which corresponds to the AIN entered by the Issuer. The system may display the data entered by the Issuer which will help the Acquirer to identify the particular dispute. In particular, the system may cause the display of the TID, NPD, number of supporting documents attached to the form, the Issuer in dispute who completed the form and the type of form. The data in the inbox may be made available for viewing and/or downloading by the Acquirer. Supporting documentation may be viewed by downloading from the application to the terminal's local hard drive or network (LAN). The Acquirer is not required to complete fields on the viewed form, but is simply alerted to the request for documentation (e.g., receipt copies) from the party in dispute. The Acquirer may then return to the “Form Selection” screen and choose a form to complete in response to the inbox request.

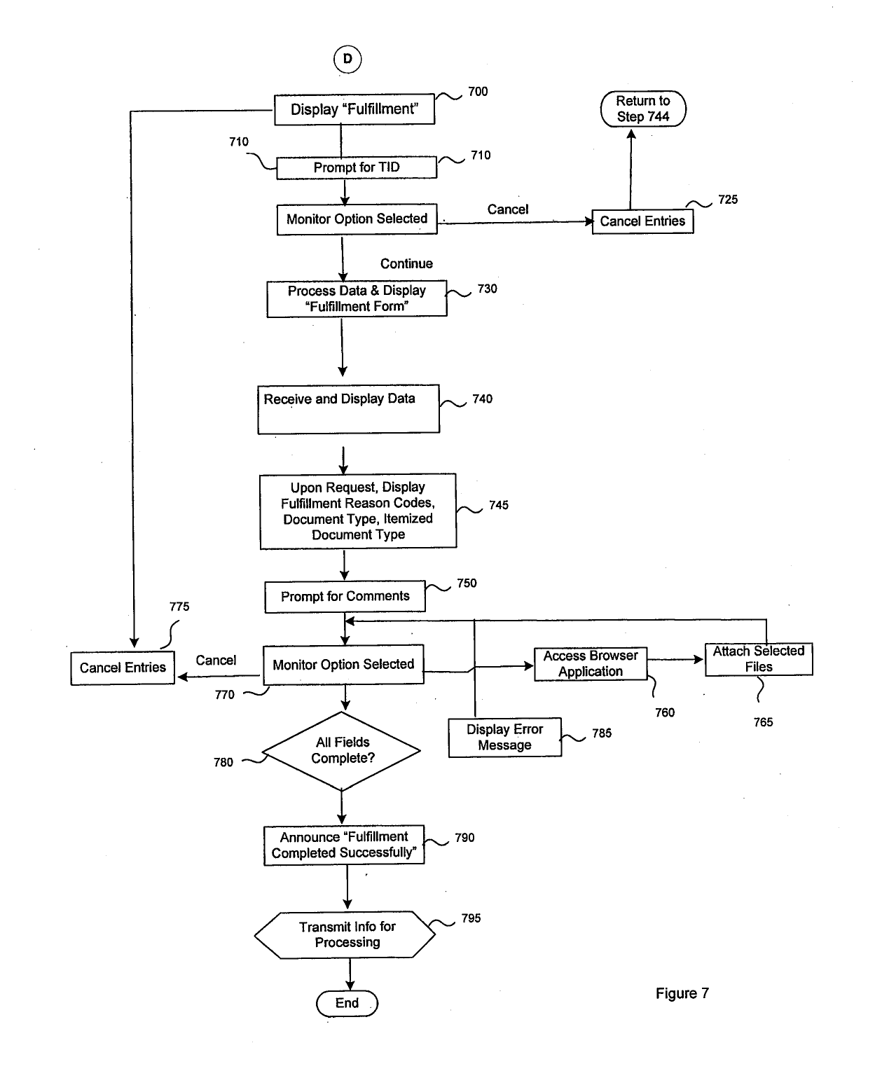

Referring now to FIG. 7, in response to the Issuer's retrieval request, the Acquirer may choose the “Fulfillment” option from the “Acquirer Form Selection” screen display. The fulfillment form may be means for the Acquirer to provide the requested information or documentation back to the Issuer. The system may cause the display of “Fulfillment” (step 700) and may prompt the Acquirer to input the TID (step 710). The Acquirer has the option to continue or cancel the entry, which is monitored by the system (step 720). The Acquirer may choose the “cancel” option and the system will cancel the current process (step 725) and return the application to the previous screen (step 544).

Should the Acquirer choose “continue,” the system may begin processing the entered data and may cause the display “Fulfillment Form” (step 730). To assist the Acquirer in completing the form, the system may display the data previously entered by the Issuer. The system may retrieve data from the previous form (retrieval request) and automatically populate any displayed fields on the fulfillment form which are identical to the data entered by the Issuer (e.g., cardmember number, S/E data, reason codes) (step 740). The system may prompt the Acquirer to choose from a drop-down menu containing a list of fulfillment reason codes (step 745) which may include codes for “supporting documentation to follow” and “credit previously issued.” The system may also accept any comments from the Acquirer (step 750).

The system monitors the next option selected by the Acquirer (step 770). For example, the Acquirer may choose “cancel” and the application would then cancel the entries (step 775) and return to the previous screen (step 700).

In response to the Issuer's request, the Acquirer may need to supply supporting documentation. The end-user may operate a scanning device to transform any supporting documentation into computer readable format. The scanned image may be transformed into a JPEG (joint photographic experts group) image file or .jpg file and stored on the user's local hard drive or network.

If the Acquirer has properly scanned documentation in support of the request, the Acquirer may select the “browse” option to review the stored image files. The system may be suitably configured to launch access to a stored application such as, for example, WINDOWS EXPLORER®. (step 760). If the Acquirer wishes to attach supporting scanned documentation, or any other type of documentation (e.g., word processing document) to the fulfillment form, the Acquirer may select the desired files from the local hard drive or network and the application causes the selected files to attach to the form (step 765).

Once satisfied with the entries, the Acquirer chooses the “send” option. The system may verify that all requested fields are complete (step 780) and if items are missing and/or invalid, the system may cause an error message display (step 785). If complete/valid, the system may announce “Fulfillment Completed Successfully” (step 790) and may transmit the completed form within the server for processing (step 795).

Similar to the Inbox description above, the completed fulfillment form may be routed back to the Issuer's access terminal for viewing and/or downloading. The system may cause substantially the same display fields for the Issuer as for the Acquirer on the inbox screen. The Issuer may download and view any supporting documentation which the Acquirer has attached to the form.

Another option available to the Issuer from the “Issuer Form Selection” display (step 530), is to choose “First Chargeback.” The chargeback form may alert the Acquirer and subsequent financial personnel that the Issuer is requesting that the funds liability be transferred or “charged back” to the Acquirer. Once selected, the system may cause a display of “First Chargeback.” The Issuer may then be asked for the S/E number, cardmember number and TID. The system may identify whether a TID was entered and automatically assigns the TID from a stored algorithm if entry is missing. The system monitors the next option selected by the Issuer. The Issuer, as previously disclosed, may cancel the entries and return the application to the previous screen (step 530).

Should the Issuer choose “continue,” the system may begin processing the entered data such as, for example, deriving both the BIN and AIN in substantially the same manner as previously disclosed. The system may cause a display “First Chargeback Form.” To assist the Issuer in completing the form, the system may automatically retrieve from the previous forms (e.g., retrieval request, fulfillment) identical data and populate the identical field entries that were entered by the previous end-user (either the Acquirer or the Issuer). The Issuer may be asked to enter the card expiration date, ARN, the S/E's name, city and country, the category code and the transaction amount. The system may suitably offer a drop-down menu containing a list of merchant category codes for the Issuer to choose from.

The system may display a drop-down menu with options from which the Issuer may choose. A drop-down menu button may follow the monetary amounts the Issuer is requesting to chargeback to the Acquirer. The menu may display a list of currency codes for the Issuer to “click on” for each amount entered. Based upon the chargeback amount entered, the system may perform a series of mathematical calculations for internal accounting purposes. These calculations are not displayed to the user. Another menu option may prompt the Issuer to choose a transaction type (e.g., charge or credit). The Issuer may also be asked to provide a chargeback reason code from another drop-down menu. As previously disclosed, the chargeback reason codes may be associated with process timeframes and indexed as such by the system.

The system prompts the Issuer to provide information with respect to the chargeback which will help the Acquirer to identify the transaction, such as, for example, monetary chargeback amounts, the transaction date, NPD presentment, a financial reference number and any comments the Issuer may wish to include with the first chargeback form.

Based upon the chargeback reason code entered by Issuer, the Issuer may be asked to enter an Issuer declaration and the name of the person submitting the declaration. An Issuer declaration is a certification by the Issuer that any requisite conditions under the chargeback code has been met. Each code may have specific conditions which the Issuer must meet in order to properly use the code, for example, “that the card had been cancelled prior to the date of the chargeback,” “provide the cardmember's cancellation confirmation number,” or “provide the duplicate billing number.” The system may index the dispute by the chargeback code entered by the Issuer.

The system may monitor the next option selected by the Issuer. If the Issuer cancels the current process, the system may delete the entries and returns to the previous screen. As previously discussed, the Issuer may wish to attach supporting documentation to the first chargeback form. The Issuer may select the “browse” option, review the files stored on the local hard drive or network, then select the desired file(s). If the “browse” option is selected, the system may be suitably configured to access an application, such as WINDOWS EXPLORER®, stored on the local hard drive or network. Upon selection of the desired file(s), the system may cause the selected file(s) to attach to the form.

Once satisfied with the entries, the Issuer may choose the “send” option. The system may verify that all requested fields are complete and if items are missing, the system causes an error message display. If no error message is displayed, the system may announce “First Chargeback Completed Successfully” and transmit the completed form within the server for processing.

The system may be configured to route the dispute-related data entered by the Issuer on the first chargeback form to the Acquirer in dispute. During processing, information is extracted from the form which aids the system in determining where to route the form. The Acquirer may be alerted to the presence of the routed form with a display on the Acquirer's inbox screen.

The Issuer may complete the first chargeback form which may be routed by the system on the server to the corresponding Acquirer. The Acquirer may refute the chargeback and present the transaction back to the Issuer. To present back, the Acquirer may select a “second presentment” option from the “Acquirer Form Selection” display (step 544). By presenting back or second presentment, the Acquirer is requesting that the funds liability be transferred back to the Issuer. The system may cause a display of “Second Presentment” and prompt the user to input the TID. The next option selected by the Acquirer may be monitored. The Acquirer may wish to cancel the entries by choosing “cancel,” which may cause the system to cancel the current process.

Should the Acquirer choose “continue,” the system may begin processing the entered data and may cause a display “Second Presentment Form.” The system may retrieve data from a previous form and automatically populate the fields identical to the data entered by the Issuer on the first chargeback form. The system may prompt the Acquirer to “click” a drop-down menu and select from a list of second presentment reason codes. The second presentment dollar amounts may be displayed but may be changed by the Acquirer if they are incorrect or a different amount is desired. Based upon the second presentment (SE) dollar amount, the system performs a series of calculations for internal accounting purposes. The Acquirer then inputs the financial reference number and any comments the Acquirer may wish to include with the second presentment form.

The system may monitor the Acquirer's next selection. As previously disclosed, the Acquirer may “cancel,” “browse” or “send” the form for processing. If the “cancel” option is chosen, the system may cancel the entries. After the “send” option is chosen and all fields are complete, the system may announce “Second Presentment Completed Successfully” and transmit the completed form within the server for processing.

Upon receipt and review of the second presentment form (as disclosed previously, the Issuer is notified of the form through the “inbox” function), the Issuer may decide to complete a “final chargeback” which is chosen from the “Issuer Form Selection” display (step 530). The system may cause the display of “Final Chargeback” and prompt the user to input the TID. The next option selected by the Issuer is monitored. The Issuer may choose “cancel” or “continue” in a similar manner as previously disclosed.

The “continue” option may begin the processing of the entered data and causes a display of “Final Chargeback Form”. The application may retrieve and automatically populate the fields identical to the data entered by the Issuer on the first chargeback form or by the Acquirer on the second presentment form. The system may perform mathematical calculations on the final chargeback amount for internal accounting purposes. The system may prompt the Issuer to choose from a list of final chargeback reason codes from a drop-down menu. The final chargeback reason codes may be the same or substantially similar to the first chargeback reason codes previously discussed. The system may prompt the Issuer to input the financial reference number and any comments the Issuer may wish to include with the final chargeback form.

The system monitors the Issuer's next selection. As previously disclosed, the Issuer may “cancel,” “browse” or “send” the form for processing. If the “cancel” option is chosen, the application may cancel the entries and return to the previous screen. After the “send” option is chosen and all fields are complete, the system may announce “Final Chargeback Completed Successfully” and transmit the completed form within the server for processing.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention. It should be understood that the detailed description and specific examples, indicating exemplary embodiments of the invention, are given for purposes of illustration only and not as limitations. Many changes and modifications within the scope of the instant invention may be made without departing from the spirit thereof, and the invention includes all such modifications. Corresponding structures, materials, acts, and equivalents of all elements in the claims below are intended to include any structure, material, or acts for performing the functions in combination with other claim elements as specifically claimed. The scope of the invention should be determined by the appended claims and their legal equivalents, rather than by the examples given above. Reference to an element in the singular is not intended to mean “one and only one” unless explicitly so stated, but rather “one or more.” Moreover, where a phrase similar to ‘at least one of A, B, and C’ is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the invention has been described as a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1-22. (canceled)

23. A business metric calculating utility operating on a computer system, the business metric calculating utility comprising:
a communications module configured to receive a request for a consumer spending capacity metric, wherein the consumer spending capacity metric is indicative of an estimated amount of future expenditures for a consumer; and
a consumer spending capacity calculation module configured to calculate the requested consumer spending capacity metric based at least in part on obtaining private data associated with the consumer from at least one private data store, wherein access to the private data is restricted to authorized users, and wherein the consumer spending calculation module is configured to obtain the private data in response to receiving the request.

24. The business metric calculating utility of claim 23, wherein the business metric calculating utility is further configured to:
cause a digital representation of the consumer spending capacity metric to be displayed.

25. The business metric calculating utility of claim 23, wherein the consumer spending capacity calculation module is further configured to:
based on the consumer spending capacity metric for the consumer and further based on at least one other consumer spending capacity metric for a different consumer, predict a purchase trend for a product sold in a geographical area, wherein the geographical area corresponds to the consumer and the different consumer.

26. The business metric calculating utility of claim 23, wherein the consumer spending capacity calculation module is further configured to:
based on the request, obtain public data associated with the consumer, wherein the public data includes data acquired from one or more networked data stores that are accessible by anyone in one or more regions; and
combine the public and private data to calculate the consumer spending capacity metric.

27. The business metric calculating utility of claim 23, wherein the consumer spending capacity calculation module is further configured to:
compare the private data for the consumer to other private data associated with a different consumer, wherein the private data and the other private data indicate that the consumer and the different consumer have conducted respective transactions with a particular merchant; and
based on a comparison of the private data for the consumer to other private data associated with the different consumer, estimate a future revenue for the particular merchant.

28. The business metric calculating utility of claim 23, wherein the consumer spending capacity calculation module is further configured to:
based on the consumer spending capacity metric, predict a future sale of a product to the consumer; and
based on a prediction of the future sale of the product to the consumer, forecast an inventory for the product.

29. A method for determining consumer spending capacity metric, the method comprising:
receiving, by a computer device, a request for the consumer spending capacity metric, wherein the consumer spending capacity metric is indicative of an estimated amount of future expenditures for a consumer in a transaction account;
based on the request, the computer device obtaining, from a remote data store, data associated with the consumer, wherein the data includes public data and private data, wherein access to the private data is restricted to authorized users;
based on the obtaining, the computer device processing the received public and private data to calculate the consumer spending capacity metric; and
the computer device causing the consumer spending capacity metric to be displayed.

30. The method of claim 29, further comprising:
providing to the remote data store, by the computer device, authentication information authenticating one of the authorized users to access the private data.

31. The method of claim 29, wherein the private data includes historical transaction data for transactions that the consumer conducted using a financial transaction instrument that corresponds to the transaction account.

32. The method of claim 29, wherein the computer device causes the consumer spending capacity metric to be displayed in a graphical format.

33. The method of claim 29, further comprising:
calculating, by the computer device, a total consumer spending capacity metric for a plurality of consumers, wherein the plurality of consumers corresponds to a plurality of transaction accounts, and wherein the plurality of consumers share a common attribute of a respective one of the plurality of transaction accounts.

34. The method of claim 29, wherein the private data includes transaction history data that corresponds to a credit account associated with the consumer, and wherein the method further comprises:
identifying in the private data, by the computer device, a balance transfer transaction; and
the computer device calculating the consumer spending capacity metric based on a portion of the transaction history data that does not include the balance transfer transaction.

35. The method of claim 29, further comprising:
based on the consumer spending capacity metric, the computer device providing an incentive to the consumer.

36. The method of claim 29, wherein the private data includes transaction history data that corresponds to a credit account associated with the consumer, and wherein the method further comprises:
based on information indicating that the transaction history data includes missing transaction data, the computer device selecting, from a plurality of consumer spending capacity metric equations, one particular consumer spending capacity metric equation to calculate the consumer spending capacity metric for the consumer.

37. A system comprising:
a processor; and
a non-transitory memory having instructions stored thereon that are executable by the processor to cause the system to perform operations comprising:
receiving a request for a consumer spending capacity metric, wherein the consumer spending capacity metric is indicative of an estimated amount of future expenditures for a consumer in a transaction account;
based on the request, obtaining, from a remote data store, data associated with the consumer, wherein the data includes public data and private data, wherein access to the private data is restricted to authorized users; and
based on the obtaining, processing the received public and private data to calculate the consumer spending capacity metric.

38. The system of claim 37, wherein the operations further comprise:
based on the consumer spending capacity metric, providing an incentive to the consumer, wherein the incentive includes at least one of: a rebate, a discount, or a reduced annual percentage rate (APR) applicable to a balance of the transaction account.

39. The system of claim 37, wherein the operations further comprise:
transmitting, to the remote data store, a request to access to the private data, wherein the request includes authentication information authenticating an identity of one of the authorized users.

40. The system of claim 37, wherein the operations further comprise:
based on the consumer spending capacity metric for the consumer, adjusting a geographical sales location for a product.

41. The system of claim 37, wherein in processing the received public and private data, the operations further comprise:
based on the received public and private data, determining that the consumer has conducted transactions using at least two financial transaction instruments, wherein one of the at least two financial transaction instruments corresponds to the transaction account.

42. The system of claim 37, wherein the operations further comprise:
based on the received public and private data, determining a total amount of historical expenditures for the consumer over a time interval; and
based on the total amount of the historical expenditures, calculating the consumer spending capacity metric, wherein the consumer spending capacity metric corresponds to a future time interval.
